(19) United States
(12) Patent Application Publication
(10) Pub. No.: US 2016/0114412 A1
(43) Pub. Date: Apr. 28, 2016

(54) METHOD FOR PRODUCING A KEY COPY

(71) Applicant: Karl-Heinz BOSCH, Santa Ponsa (ES)

(72) Inventor: Karl-Heinz Bosch, Santa Ponsa (ES)

(21) Appl. No.: 14/763,884

(22) PCT Filed: Jan. 30, 2014
(86) PCT No.: PCT/EP2014/051749

§ 371 Date: Dec. 2, 2015

(30) Foreign Application Priority Data
Feb. 1, 2013 (DE) 10 2013 101 014.8
Jul. 1, 2013 (DE) 10 2013 106 856.1
Jan. 15, 2014 (DE) 10 2014 100 393.4

(51) Int. Cl. B23C 3/35; G06T 7/00; G01B 11/30; G06F 17/30; B23Q 35/40; B23Q 35/26

(52) U.S. Cl. CPC B23C 3/35; B23Q 35/40; B23Q 35/26; G01B 11/303; G06F 17/30247; G06F 17/30303; G06T 7/0004; B23C 2235/04; B23C 2235/12; B23C 2235/41; B23C 2235/48; B23C 2250/12; G06T 2207/10004; G06T 2207/30108

(57) ABSTRACT

A method for producing a key (50), wherein a data set (40) of a key is obtained by recording the surface of the key (10) and subsequently performing a data optimization (55), or from data of a data collection (46), in order to produce the key (50) from a semi-finished product clamped in a machine by a computer-controlled production method (9), wherein at least two different locking features are introduced into the semi-finished product.

### BACKGROUND OF THE INVENTION

The present invention relates to a method for manufacturing a key.

In order to manufacture or duplicate a key, preferably fitting a lock cylinder of a master key system, all lock-relevant characteristics of the key must match the master key, or the lock. These characteristics are essentially: The width, thickness, length, back rounding and tip shape of the key blade, the profile in the longitudinal direction of the blade, the thickness and breadth of the stop, the tumblers in the form of jagged cuts in the key breast and in the key back, tumblers in the form of notches or tracks on the two broad sides, the back and the breast of the key blade. To manufacture a key in accordance with a master key, or to fit a lock, key services need to perform many operations, and require a large number of individual machines and tools for this. According to the prior art, the following steps for manufacturing a conventional key are necessary:

First, the required longitudinal profile is milled with a moulder in a key blank. Thereafter, the milled blank is unclamped, fixed in a vise and the length of the blade adjusted with a saw. Now the tip must be manually filed, or be processed with a grinding/milling machine. The thus prepared blank is clamped with the blade in a teeth milling machine and accurately aligned. In this milling machine, the teeth are then milled into the breast of the blank. For this purpose, suitable clamping jaws must be selected in order to fix the blank firmly enough in the machine. To mill teeth in the back, the key must be unclamped, rotated 180 degrees, re-clamped and aligned exactly. Now the teeth can only be milled in the back. Afterwards, the semi-finished key is unclamped from the teeth milling machine. In order to mill notches into the key, the key service requires a notch milling machine. A milling cutter suitable for the notches must be clamped, and the machine must be calibrated. The blade of the key, with the first broad side facing up, is clamped in the notch milling machine and precisely aligned. Since the key already has teeth, various, special clamping jaws are required to tighten the blade of the key well. Nevertheless, it often happens that the blade of the key slips during processing of the machine, and so the duplicate becomes unusable. By clamping the blade, only the upper broad side of the key is free for processing. After the milling of the notches in this broad side, the key must be unclamped, turned 180 degrees, and be clamped and aligned again. There is then the milling of the second broad side. Now the key is unclamped again, rotated 90 degrees, clamped to the blade, to provide the back with notches. This process for the notches of the breast may need to be repeated. Now the stop must still be manually adapted to the key in its thickness and width, or in a manual milling machine. For this purpose, it is again necessary to fix the already processed blade of the key well, which is complicated, because the key usually has no planar, parallel surfaces with which to fix it reliably. Finally, the key is clamped in an engraving machine to engrave the same inscription as the master key.

A disadvantage of this prior art is that the various individual processing machines, and the respective clamping devices are designed to clamp the key to its blade and align exactly to a stop. The predominant part of the blade is concealed in the clamping device and cannot be reached by the milling tools, which makes frequent shifting necessary. In addition, the processed blade usually has insufficiently planar surfaces on which the keys can be fixed with sufficient firmness. The consequence is that the key often slips during milling, and so this key will not fit because the milled tumblers have incorrect dimensions, or are incorrectly positioned. In addition, the risk is very high that the key is not made true to size, because the orientation of the key before the respective work steps is not performed perfectly accurately. Another problem is that there is no common reference edge for gripping the key for the individual steps, because each machine has different clamping jaws. So it often happens that the millings are not properly mounted relative to each other. The skilled worker must expend much time for the manufacturing, because he must actively participate in the manufacturing process the entire time in order to shift and mill the key. This leads to a very high price of the key. If more than one key are manufactured at the same time, all of the above named steps are necessary again for each duplicate. If a new key family comes onto the market, the locking characteristics have an up-to-now unusual mechanical design, so the key service must again buy another machine to be able to mill this configuration of the locking. So the machinery becomes larger every year and the operation of each machine is more complex.

In another conceivable method according to the prior art is capturing the surface of the master key and manufacturing a duplicate using the data obtained therefrom. The next machine to be used for the milling of the corresponding tumblers has a table on which a semi-finished product can be clamped and a movable milling spindle which processes this semi-finished product. A disadvantage of this method is that different milling cutters must be used for the manufacture of differently configured tumblers. This must either be clamped and calibrated manually before each work step, or the machine needs an automatic, industrial tool change system and an industrial milling spindle suitable for it. These parts are very expensive and complicated to use. In addition, one needs cleaned compressed air for this and very complex machine control. Due to this cost, the production of keys is uneconomical. To make matters worse, the corresponding milling cutter must be oriented in different directions, horizontal, vertical, and rotated by 90 degrees for the milling of different tumblers and profiles of a key. The corresponding milling spindle must have rotary axes for this, which additionally increases the cost of the machine. In addition, all errors on the key copy that arise from recording are carried over.

Two different methods are known for recording the surface contour of a key. The first method uses a mechanical scanning device to scan the profile of the key in small steps. Here, however, one does not receive information about the formation and the dimensions of the locking-relevant tumblers in the form of teeth or drill notches. The second method records the surface of the key by means of optical sensors. However, this process is unsuitable for obtaining the exact profile of the key blade because the depth and arrangement of the profile slots cannot be determined accurately enough. In addition, it is very costly to extract the exact profile from the images of the key.

In order to manufacture a custom-fit key copy corresponding to a master key, the key copy, primarily the profile and the tumblers, must lie within close tolerance limits. One designates the profiling of the key shaft in the longitudinal direction for cylinder keys. This profile must be manufactured within the narrow tolerance limits, otherwise the key cannot be inserted into the associated lock cylinder.

Tumblers are areas of the key which are scanned by the movable elements of the lock cylinder or the lock. For example, frequently encountered tumblers are teeth on the narrow sides of commercial cylinder keys, milled notches on the broad sides, milled tracks in key shaft or cuts in the key bit. The profiles and configurations for the tumblers of modern keys continually become more varied, making the manufacture of key copies more difficult.

Tumblers must also be designed in very narrow tolerance limits, commonly a few hundredths of a millimeter, to guarantee the activation of the lock cylinder or lock. This complicates the manufacturing of key copies, since naturally the key copies must lie within these tight tolerances in order to function properly.

The U.S. Pat. No. 6,647,308 B1 and the corresponding DE 601 30 230 T2 describe a method for producing a duplicate key. At this juncture, the configuration of the surface of the master key is recorded by various known methods in order to directly produce a key duplicate from raw materials by means of the data obtained therefrom.

Other publications describe the production of key duplicates in which the configuration of the surface of the master key is recorded in order to transfer these data directly onto a key blank.

A disadvantage of this method is that the data arising from the recording of the surface of the master key, for technical reasons, has frequent mistakes, very high deviations, and missing areas. The key copy directly manufactured from this data record then does not fit the lock cylinder or the lock. If, for example, the recorded profile deviates in only one place from the required tolerance, the duplicate key manufactured therefrom cannot be introduced into the lock cylinder. If only one tumbler, or part of a tumbler is outside of tolerance, the duplicate key will not be able to turn in the cylinder/lock.

Object of the present invention is to eliminate the aforementioned drawbacks to produce an error-free, perfectly fitting key from the data of the surface of a key. In addition, to ensure that the manufacture of keys is designed fast, inexpensive, easy and future-proof. Another object is to use the data of the recorded surface of the master key to determine an appropriate key blank.

### SUMMARY OF THE INVENTION

The object is achieved by the method according to the present invention.

In a method according to the invention, the configuration of the surface of a master key is recorded. The errors and deviations of the recorded surface data are compared and optimized by a data optimization with error-free reference data. A semi-finished product is built from a plurality of modules in a clamped manufacturing device. The corrected data are used to process the semi-finished product automatically by milling with the different modules in order to manufacture a perfectly fitting duplicate key.

In a method according to the invention, all methods that are used to record the surface are used for recording the master key. Preferably, scanning by measuring elements, recording by optical elements, recording by light waves, recording by sound waves, recording by three-dimensional recording methods such as, for example, laser stripe triangulation or stripe light projection. The surface contour determined therefrom can be compensated using existing reference data and saved as a data record in electronic form.

In a method according to the invention, the surface contour of a master key is recorded by means of a recording process consisting of a combination of mechanical scanning and optical recording and stored as an electronic data record. A recording device according to the invention with a mechanical scanning unit and camera is used here.

The individual steps of the method according to the invention for recording the surface structure of a master key are as follows:

In the key holder of a recording device according to the invention, the master key is clamped and fixed in the correct position from which a duplicate is to be made. A mechanical scanning unit tactilely scans the profile of the master key on its surface, and so generates an image of the key profile in electronic form. A camera photocopies the keys repeatedly while the key holder, together with the fixed key, turns. The surface contour of the master key can be calculated from the photocopies gained therefrom. Together with the data of the previously recorded key profile, all lock-relevant characteristics of the master key can be stored for further processed in the form of an electronic data record. In addition, the recording device is able to determine a key blank, if available, suitable to the profile of the master key.

A recording device according to the invention essentially consists of a computing unit, a plurality of electronically movable linear rotary axes, a scanning unit, a camera and a key holder.

In a method according to the invention, deviations, errors of the recorded data of a master key can be corrected by means of data optimization. The reference data for the data optimization can be derived in this case from a database in which the previously measured surfaces of keys or partial areas of keys are stored. Also, data records can be used to optimize data derived from previously manufactured, error-free copies of keys. By adding data of key copies that have been confirmed by the customer as accurately fitting, the database of the data optimization becomes increasingly powerful. If only partial areas of the recorded data record are faulty, these areas can be corrected by the process according to the invention using other, error-free areas of the recorded key.

Also, missing dimensions in the recorded data record can be filled by the process according to the invention. For example, if a cylinder key with so-called drill notches is recorded by means of a two-dimensional camera, one only gets the size of these drilled notches. The depth of the notches can be determined by comparison with notches of equal diameter stored in the database.

The stored keys are organized into logical groups in the database of the data optimization. Preferably, the top hierarchy is formed by the make of the key. Among them are the individual series of cylinders/locks. Thus, the recorded data record can be easily assigned to the corresponding make based on the make stamped on the head or its head shape. The series of the recorded key can be detected by other characteristics such as shaft length, shaft width, shaft thickness, angle of the tip, total length of the master key. Now the erroneous data record can be easily corrected through the characteristics of the corresponding series stored in the database. The correction of erroneous data can be done automatically by intelligent software. The software compares the recorded data with the data from the database to find a key stored there that corresponds to the data record. By means of a variably formed blur in the program, a corresponding reference key is then found, even if the recorded data record deviates from the error-free, stored data due to its error. The software replaces the faulty parts of the recorded data record by the error-free areas of the reference data record found.

Employees can manually correct the recorded data records of the configuration of the surface of the master key by means of the software of the method according to the invention. Here, similar to drawing software, missing areas can be added, or protruding areas can be removed. Reference data from the database support the correction here. The corrected data can be buffered for later use. In the method according to the invention, the database can also store information for the manufacture of duplicate keys in the respective data records. Through this, data records for the manufacture of duplicates keys can be generated, which are optimized corresponding to the manufacturing method used. Manufacturing tolerances can thus be compensated. It is also possible to store known tolerances areas of several key makes or key series in the database. Thus, data in the data records can be corrected in accordance with the known tolerances.

In an inventive method, the data record for manufacturing a key can be derived from an electronically stored data record. The information about this data record can be derived, for example, from manufacturing data for the key, from data from the recorded lock cylinder, or other data originating from keys.

In a process according to the invention, data for the matching key blank can be determined by means of the data obtained through the recording of the surface of the master key. Here, the corrected data are compared to reference data of key blanks to determine the most similar blank.

In a method according to the invention, various manufacturing processes, such as material abrading processes such as milling, drilling, scraping, sanding and material building processes such as laminated object modeling, stereolithography, fuse deposition modeling, selective laser sintering or selective laser melting for the production of a key can be used.

In a method according to the invention, an electronic data record of the surface contour of a key is used to manufacture a key. Here, the different locking characteristics are consecutively milled into the semi-finished product by means of a modular processing unit. Here, the semi-finished product remains clamped in the same way in a semi-finished product module, preferably for the entire machining process. All major components of the processing unit are constructed as so-called modules, and each can be replaced as needed. New modules can be integrated at any time and thus always keep the processing unit up to date.

The individual steps of the method according to the invention for manufacturing of a key are as follows:

In the semi-finished product module of a manufacturing device according to the invention, a semi-finished product, preferably a plate made of metal, is clamped at its head and its tip so that the entire blade area of the semi-finished product lying between them is exposed. Clamping the head and at the top ensures that the blade of the semi-finished product does not bend or vibrate during the processing. The semi-finished product module is fastened to a linear three-dimensionally movable positioning unit, and can be moved freely by it, together with the fixed semi-finished product. The control module of the device according to the invention moves the semi-finished product to different milling modules of the inventive device corresponding to the electronic data record in order to mill in the corresponding lock-relevant characteristics. This milling module and the milling cutter clamped therein are positioned so that they can introduce the respective milling into the semi-finished product clamped on the head and the tip without requiring release or shifting of the semi-finished product. Thus, all work steps automatically run consecutively, until a precisely fitting, complete key is manufactured.

A manufacturing device according to the invention consists of a control module, a processing base and modules installed thereon. The units can be accommodated for mobile use in transport cases. Rechargeable batteries or a mains connection supply the components with power. The control module consists of a computing unit and a final stage for controlling the processing base and its modules. The processing base consists of three linear axes on which a semi-finished product module can be mounted for swivel or rotation. This semi-finished product module has clamping jaws for fixing a semi-finished product. In addition, the semi-finished product module can be equipped with a rotary axis by means of which the semi-finished product can be rotated. A plurality of milling modules, consisting of milling motors, spindles and clamped milling cutters can be installed on the table of the processing base. This milling module can be, as needed, installed or removed to various module slots of the table of the processing base. The modules and/or the module slots can be mounted for rotation or swivelling on the table. Among other things, the following milling modules for processing the semi-finished product are possible: End milling cutter modules, equipped with differently configured end milling cutters for milling drill notches, external contours, key tip, key stop, tracks and engraving, side milling cutter modules, equipped with differently configured side milling cutters for milling teeth, cuts, Chubb tumblers, profile milling cutter modules, equipped with various mini disc milling cutters for milling profiles, grooves.

The control module and the processing base can be connected by means of a cable in order to transfer the control signals from the final stage of the control module to the axes, motors of the processing base and their modules.

The final stage calculates the required machine data for the control of the processing base from the data record of the key stored in the computing unit. The semi-finished product module is connected to the three linearly movable axes of the processing base and can be moved in all three spatial directions by means of these axes.

To manufacture a key, a semi-finished product is clamped and fixed in the correct direction with the head and the tip in the semi-finished product module. The final stage of the control module controls the linear axes now so that the semi-finished product is driven to the first milling module, the profile milling cutter module. The profile milling cutter or mini disc milling cutter in the milling spindle of profile milling cutter module project into a coolant container filled with coolant. Now the semi-finished product is guided along the milling cutter according to the profile data of the key data record so that little by little the appropriate profile is milled into the two exposed broad sides of the semi-finished product. The coolant cools and lubricates the milling cutters and the semi-finished product here and prevents overheating and wear. After that, the processing base positions the semi-finished product module to the start position of the side milling cutter module. The required tumbler teeth are milled into the freestanding breast/back area of the semi-finished product. Next is the milling of the notches in the semi-finished product by means of the end milling cutter modules. If the data record of the key provides for a rounded back on the duplicate key, the semi-finished product is correspondingly processed with a special milling cutter on the end milling cutter module. Then follows the engraving on the head of the still fixed semi-finished product. Now follows the milling of thickness and width of the key stroke and the attachment of the key tip. Now the completed key can be unclamped from the semi-finished product module. Manual finishing is no longer necessary. All work steps of the modules in the processing base are performed automatically, one after the other, controlled by the control module. If another duplicate is to be manufactured, only a new semi-finished product needs to be fixed in the semi-finished product module and the process can be restarted by pressing the button on the control module. Keys can be manufactured quickly and inexpensively. In particular, several duplicates can be made from just one recording, since the information necessary for the manufacture of a duplicate is stored. Errors due to incorrect shifting or incorrect repositioning are excluded because the semi-finished product remains clamped in the same way on the head and the tip during the entire processing.

The operator can execute other tasks during processing because the entire production process runs automatically.

For a configuration of an inventive semi-finished product module, the clamped semi-finished product with the head and tip can be rotated about its longitudinal axis. This allows more options for milling processing, since the semi-finished product can hereby be placed in any desired angle to the milling cutters.

For the transport of the processing unit, it should be ensured that the refrigerant does not exit uncontrollably from the coolant container. For this purpose, the refrigerant container may be sealed with a lid, wherein the milling cutter is moved beforehand from the area of the container. It is also possible to extract the refrigerant from the coolant container, for example by means of a large syringe.

The carrying case of the processing unit can be closed during operation in order to dampen noise, and to ensure that no chips or coolant escape.

### BRIEF DESCRIPTION OF THE DRAWINGS

Further advantages, characteristics and details of the invention become apparent from the following description and on the basis of FIGS. 1 to 28, wherein:

FIG. 1: is a flow diagram of one embodiment of the method of the present invention;

FIG. 2: is a variant of the data optimization of the method of FIG. 1;

FIG. 3: is a further variant of data optimization of the invention;

FIG. 4: is a still further variant of data optimization of the method of the invention;

FIG. 5: is a detailed view of the data optimization of the invention;

FIG. 6: shows data optimization of tumblers;

FIG. 7: illustrates a hierarchically constructed database of data optimization;

FIG. 8: is a perspective view of a manufacturing device of the present invention;

FIG. 9: is a further perspective view of a manufacturing device of the invention;

FIG. 10: shows a detailed view of the module slot and milling cutter module of the manufacturing device of FIG. 9;

FIG. 11: shows details of the end milling cutter module of FIG. 10;

FIG. 12: shows details of a side milling cutter module;

FIG. 13: shows details of a profile milling cutter module;

FIG. 14: shows the configuration of a control module;

FIGS. 15 through 17: show three views of the configuration of the semi-finished product module;

FIG. 18: shows the semi-finished product module during processing by the module of FIG. 11;

FIG. 19: shows the semi-finished product module during processing by the module of FIG. 12;

FIG. 20: shows the semi-finished product module during processing by the module of FIG. 13;

FIG. 21: shows a key manufactured by the method of the present invention;

FIG. 22: shows a combination milling cutter for use in the end milling cutter module of FIG. 11;

FIG. 23: illustrates a prior art key;

FIGS. 24 through 26: show an inventive recording device;

FIG. 27: shows the key holder in the recording device; and

FIG. 28: shows a clamping adapter.

### DETAILED DESCRIPTION

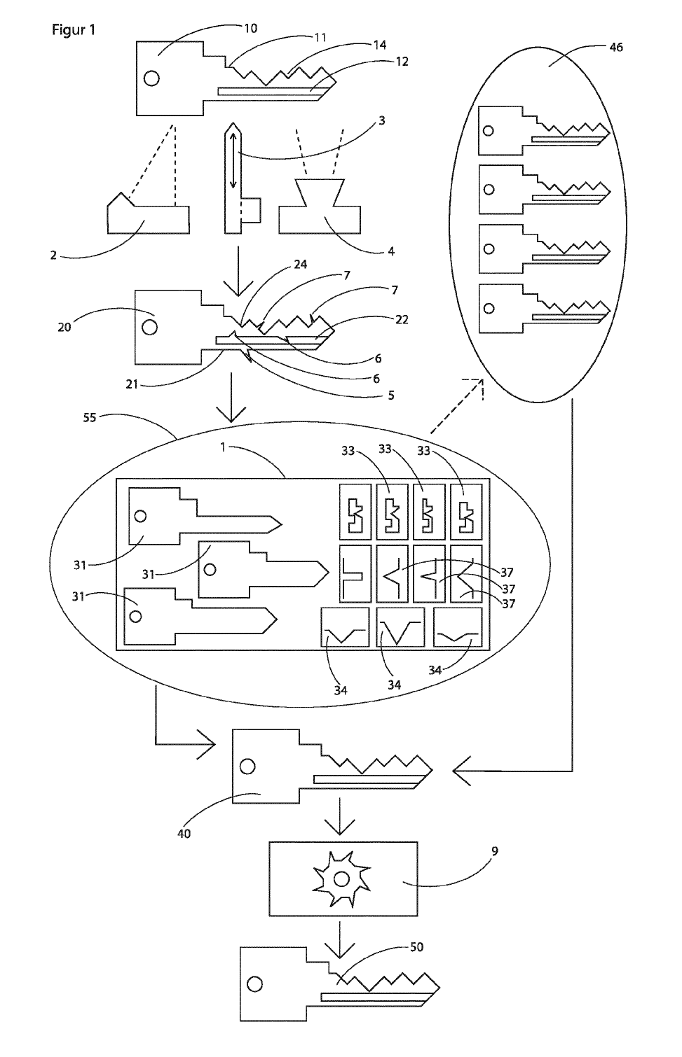

FIG. 1 shows the method according to the invention as a simplified diagram. Here, the configuration of the surface of the key 10 is recorded with its outline contour 11, the tumblers 14 formed from cuts, and the profile 12 of the recording process in the form of laser line triangulation 2, the mechanical sensing elements 3 and/or of the camera 4. The data record 20 resulting from this recording has error 7 on the tumblers 24, error 6 on the profile 22, and error 5 on the outline contour 21. The errors are hereby detected by corresponding software, for example, where a plausibility check is carried out. By optimizing data 55, the faulty outline contour 21 of the data record 20 is compared manually or by means of software to the error-free outline contour 31 stored in the database 1, in order to determine the appropriate data record. Now error 5 can be corrected through the error-free points of the outline contour 31, or the complete, error-free outline contour 31 can be used again. Similarly, the error 6 in the profile 22 can be corrected or replaced by the error-free profile section 33 and/or by the error-free profile area 37. The errors 7 of the tumblers 24 are compared to error-free tumblers 34. The so corrected, error-free data record 40 is now used to manufacture a fitting duplicate key 50 by means of computer controlled manufacturing 9. The data collection 46 contains data from the surface of keys, which may also be used to generate a data record 40. The data resulting from the optimization 55 can also be stored in a data collection 46.

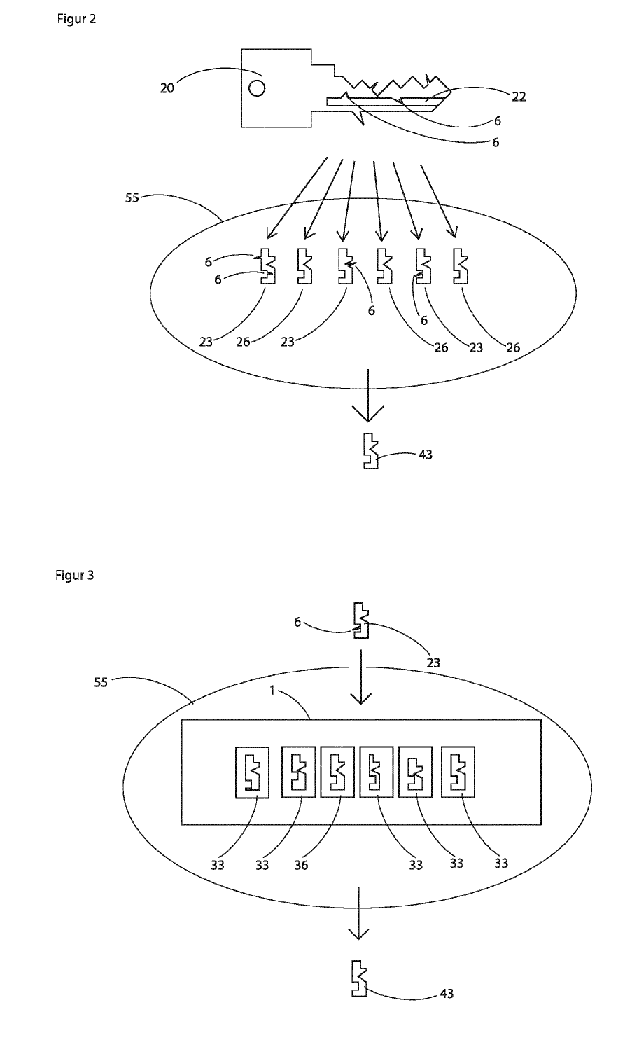

FIG. 2 shows a variant of data optimization 55 of the method according to the invention without support of a database filled with data from other keys.

The data record 20 of the recorded key 10 has, among other things, error 6 at sections of the profile 22. If, during the data optimization 55, the data record of profile 22 running along the key is divided into individual data records of the profile cross-sections 23, 26, some data records 23 have error 6, other data records 26 are error-free, however. By manual or software controlled superimposition of records 23, 26, error 6 can be detected in a simple way and these areas of the profile be replaced by error-free areas. The thus corrected data record 43 of the profile cross-section can now be used to make the profile of the matching key copy.

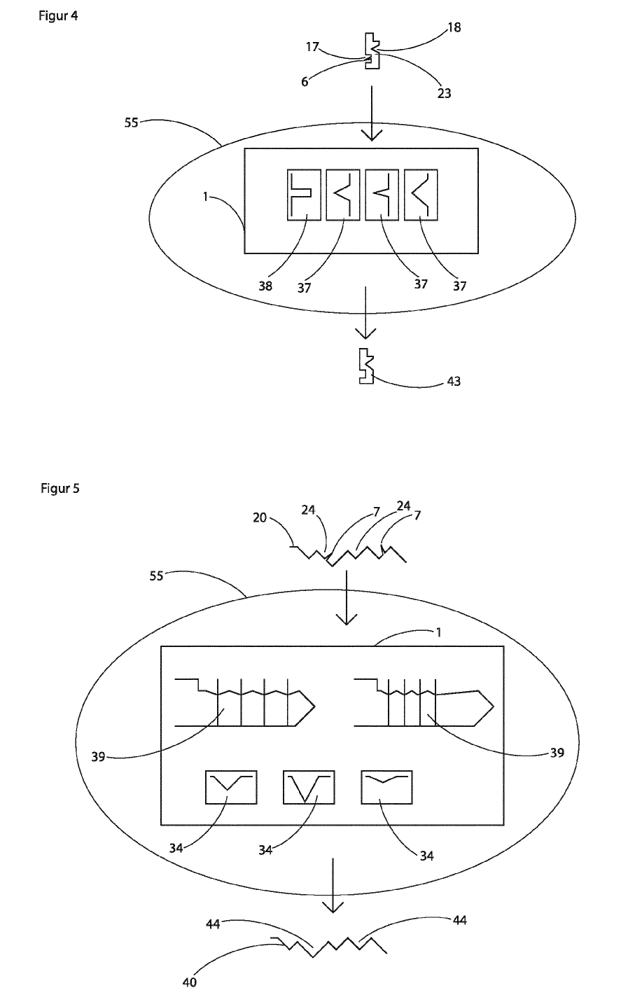

FIG. 3 shows a variant of data optimization 55 of the method according to the invention with support from a database 1 filled with data from other keys. The flawed profile cross-section with errors 6 arises from the recording of the surface of a key. The database 1 contains error-free records 33, 36 of profile cross-sections of measured reference keys or previously manufactured key copies that had matched. The profile cross-section 23 is compared with the data optimization 55 manually or by intelligent software to the profile cross-sections 33, 36. The profile cross-section 36 can be detected as a fitting cross-section. The data record 43 of the profile cross-section can now easily be generated from the data record 36, or from the data record 23 corrected by data record 36. Now this data record 43 can be used to create a duplicate key by means of computer-controlled manufacturing, or to determine an already manufactured key blank with an identical profile.

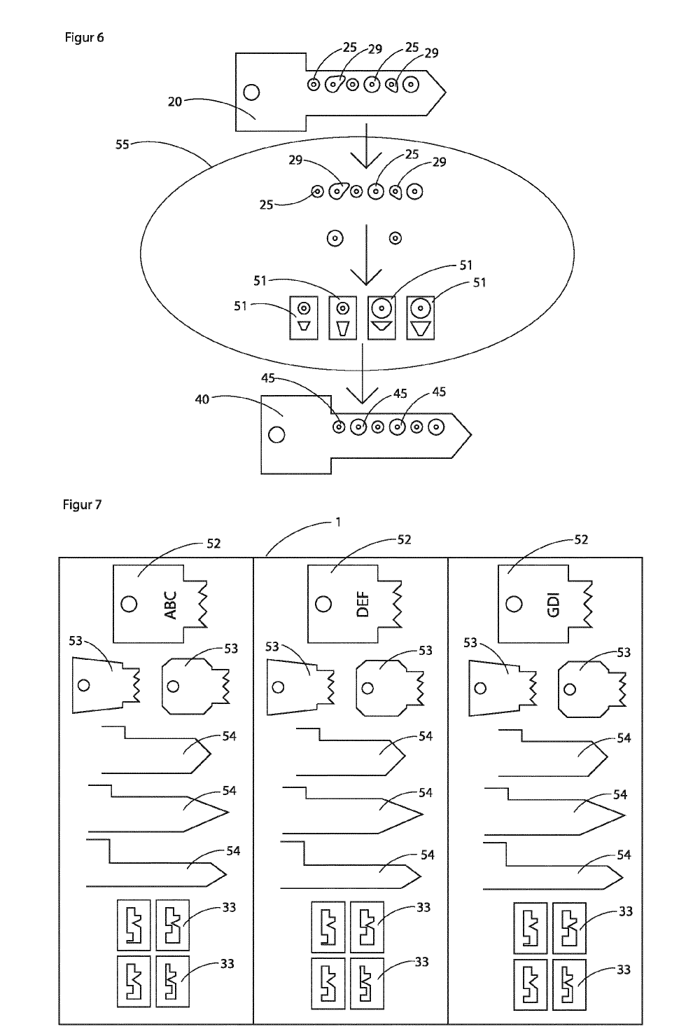

FIG. 4 shows a further variant of the data optimization 55 of the method of the invention. The profile cross-section 23 for the recording of the key consists of several profile sub-areas 17, 18, here in the form of grooves. The section 17 is distorted by the error 6. The database 1 of the data optimization contains error-free profile sections 38, 37 of different designs. To correct the error 6, the profile section 17 is simply compared to the profile sections 38, 37 in the database.

The profile section 38 is found there, which corresponds to the shape and dimensions of the profile section 17. Now, the error 6, which deviates from the norm of the profile section, can easily be corrected.

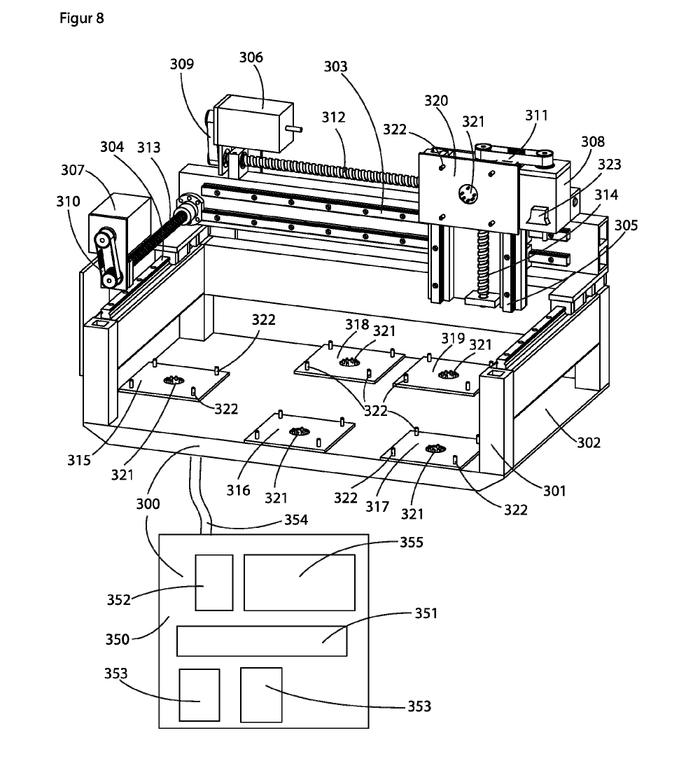

FIG. 5 shows a detailed data optimization 55 of the method according to the invention. The tumblers 24, of the data record 20 resulting from the recording of the key, formed here as cuts, have error 7 that excludes a direct use of the data record for the production of a duplicate key. It is known that error-free data records of tumblers 34 and tumbler patterns 39 are stored the database 1 of the data optimization 55. The data record 20 is compared to the error-free data records of the tumbler patterns 39 in order to correct the distances among the tumblers 24. In addition, the individual tumblers 24 are matched with the data records 34 of the different configurations of the tumblers. As a result, a data record 40 is obtained with error corrected tumblers 44, which can be used for the computer-controlled production.

FIG. 6 shows a data optimization of tumblers 25, 29 that are configured as drill notches. The data record 20 from the recording of the key contains tumblers 25, 29 in the form of so-called drill notches. The original design of this type of tumbler 25 is normally round. The misshapen tumblers 29 in data record 20 were mapped incorrectly by the recording process. A data optimization 55 of these drill notches 29 can either be done by comparing to other, error-free, round tumblers 25 of the same data record 20, or by comparing them with error-free data records in a database. In addition, the depth of the drill notches 25 can be determined based on the depth references 51 in the database. For this purpose, only the type of recorded key needs to be determined. This can be done very easily, the manufacturer is usually indicated on the key head. With the knowledge of the type of the key, the depth of the drill notches 25 can be determined.

The drill notches 25 are milled conically in the surface of the key. Using the depth references 51 stored in the database, the depths can be determined based on the diameter of the drill notches 25, even if the data record 20 only comes from a two-dimensional recording process.

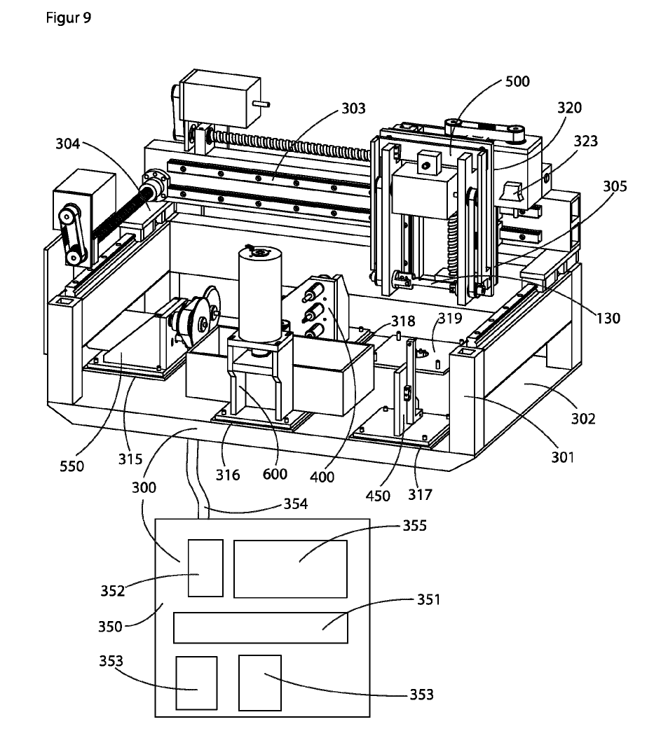

FIG. 7 shows a hierarchically constructed database 1 of the data optimization 55 of the method according to the invention. It is used to identify the corresponding references for the data record of the recorded keys. To this end, the make embossed in the key head of the recorded key is compared with the makes 52 in the database 1. Due to the head shape 53 and the configuration of the key shank 54, the recorded data record can then be assigned to a specific key series. The recorded profile must then be compared only with the few profile cross-sections 33 of the detected series. Now the recorded key is accurately assigned to an error-free reference key from the database 1. A corresponding key blank can then be determined in a simple way, or the error of the recorded data record can be corrected by the reference of database 1 in order to produce an exact fit duplicate key.

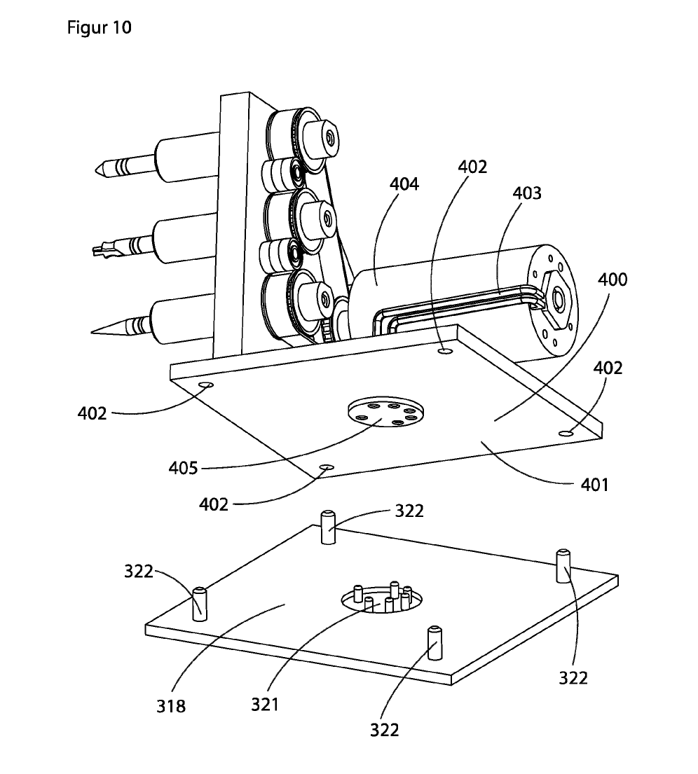

FIG. 8 shows an embodiment of an inventive manufacturing device 300 in a perspective view. The processing base 301 consists of a table 302 with the linear axes X axis 303, Y axis 304 and Z axis 305. The X axis 303 has a motor 306, the belt drive 309 and the spindle drive 312. The Y axis 304 consists of the motor 307, the belt drive 310 and the spindle drive 313, the Z axis 305 of the motor 308, the belt drive 311 and the spindle drive 314. A camera 323 sits on the Z axis 305. On the table 302 are arranged several module slots 315, 316, 317, 318, 319 together with their plug contacts 321 and four locking pins 322 each. A module slot 320 with plug contacts 321 and four locking pins 322 are arranged on the Z axis 305.

The control module 350 is connected to the processing base 301 by means of the cable 354 and consists of the computing unit 351, the screen 355, the final stage 352 and the batteries 353.

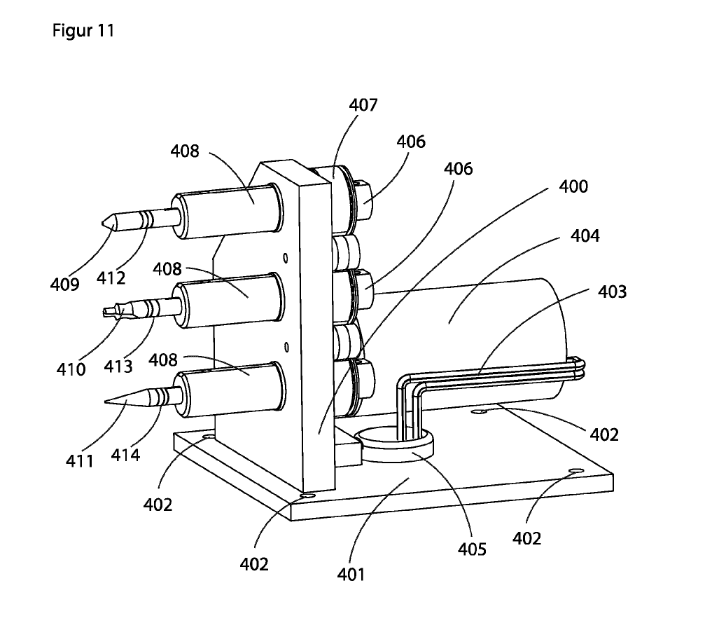

FIG. 9 shows an embodiment of a manufacturing device 300 in perspective view. The processing base 301 is equipped with an exemplary variation of plugged modules. A side milling cutter module 550 is installed on the module slot 315 of the table 302, a profile milling cutter module 600 on the module slot 316, a control module 450 on the module slot 317, an end milling cutter module 400 on the module slot 318. The module slot 319 is free, and can be optionally equipped with an additional, arbitrary module. The semi-finished product module 500 is fixed on the module slot 320 of the Z axis 305. All module slots 315, 316, 317, 318, 319, 320 are designed so that any module can be installed on any module slot. A camera 323 is additionally attached to the Z axis. The control module 350 is connected to the processing base 301 by means of the cable 354 and consists of the computing unit 351, the screen 355, the final stage 352 and the batteries 353. Thus, the two units can be accommodated separately in a mobile carrying case, and the electronic components of the control module 350 are protected against milling chips and coolant from the processing base 301. A semi-finished product 130 is fixed in the semi-finished product module 500.

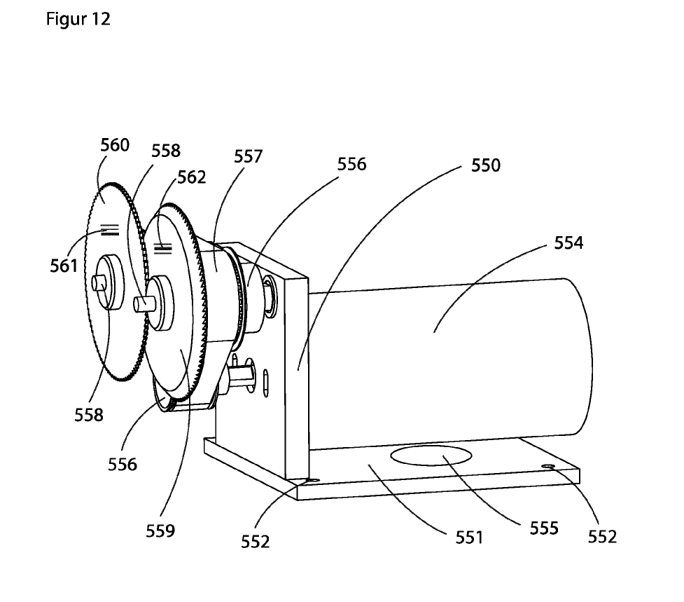

FIG. 10 shows the module slot 318 in conjunction with the end milling cutter module 400. The end milling cutter module 400 consists of mounting plate 401 with 4 fixing holes 402, a socket 405, a connecting cable 403, a motor 404. The module slot 318 has 4 locking pins 322 and electrical plug contacts 321.

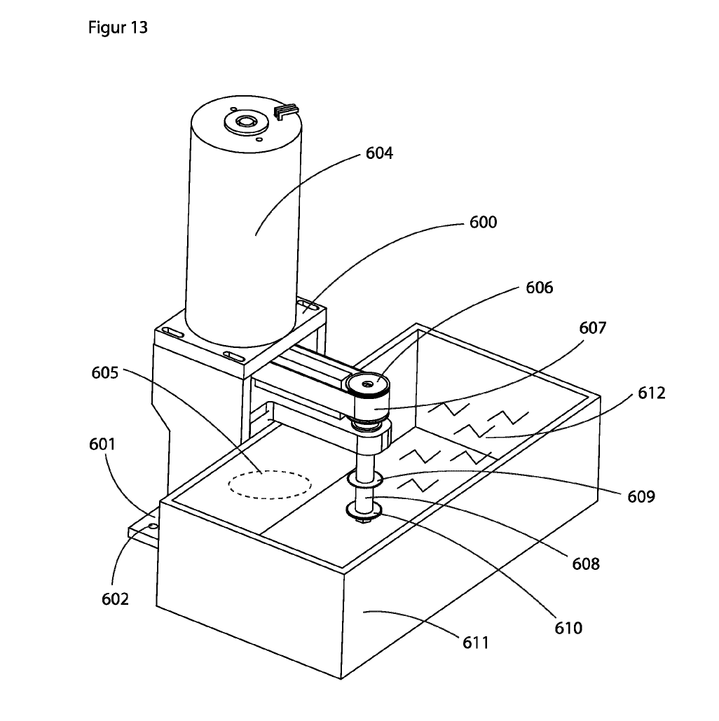

FIG. 11 shows an exemplary configuration of an end milling cutter module 400. Four fixing holes 402 and a socket 405 are attached in the mounting plate 401. The motor 404 is connected by a cable 403 with the plug contacts of the jack 405. The motor 404 drives the three milling spindles 408 via the toothed belt 407 and the toothed belt wheels 406. The end milling cutters 409, 410, 411 are inserted into the milling spindles 408. The milling cutters carry a bar code 412, 413, 414 for automatic identification.

FIG. 12 shows an exemplary configuration of a side milling cutter module 550. Four fixing holes 552 and a socket 555 are attached in the mounting plate 551. The motor 554 is connected to the plug contacts of the jack 555 by a cable. The motor 554 drives the two spindles 558 via the toothed belt 557 and the toothed belt sprockets 556. The side milling cutters 559, 560 are inserted in the spindles 558, which are marked with the bar codes 561, 562.

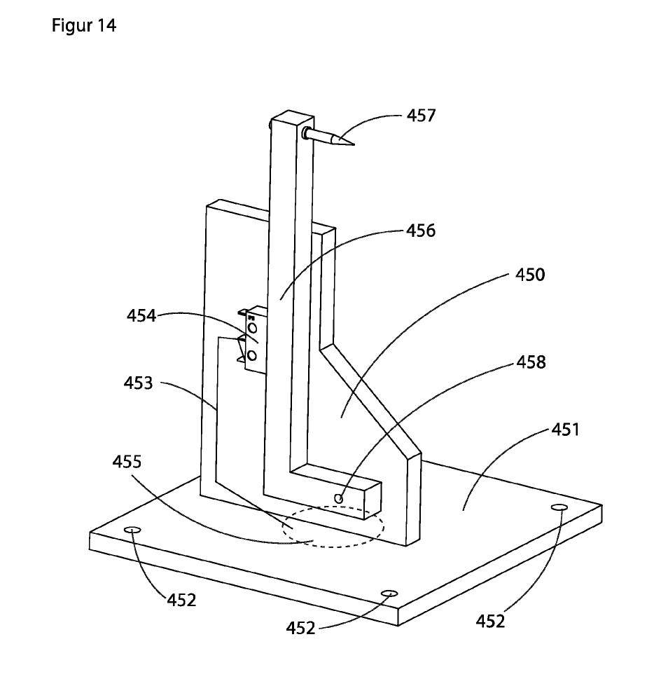

FIG. 13 shows an exemplary configuration of a profile milling cutter module 600. Four fixing holes 602 and a socket 605 are attached in the mounting plate 601. The motor 604 is connected to the plug contacts of the jack 605 by a cable. The motor 604 drives the milling spindle 608 via the toothed belt 607 and the toothed belt sprockets 606. The mini disc milling cutters 609, 610 are inserted in the milling spindle 608. The milling spindle 608 and the two mini disc milling cutters 609, 610 are immersed in the coolant 612 of the coolant container 611.

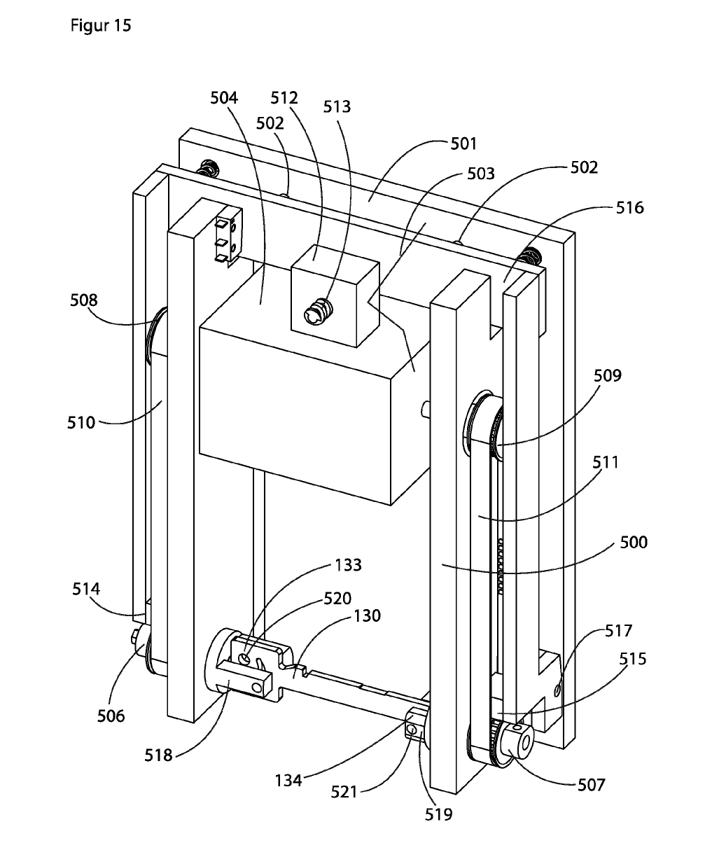

FIG. 14 shows an exemplary configuration of a control module 450. Four fixing holes 452 and a socket 455 are attached in the mounting plate 451. The sensor 454 is connected with the plug contacts of the jack 455 by a cable 453. The control needle 457 is fixed to the control bar 456. The control bar 456 is rotatably mounted by means of the rotation axis 458.

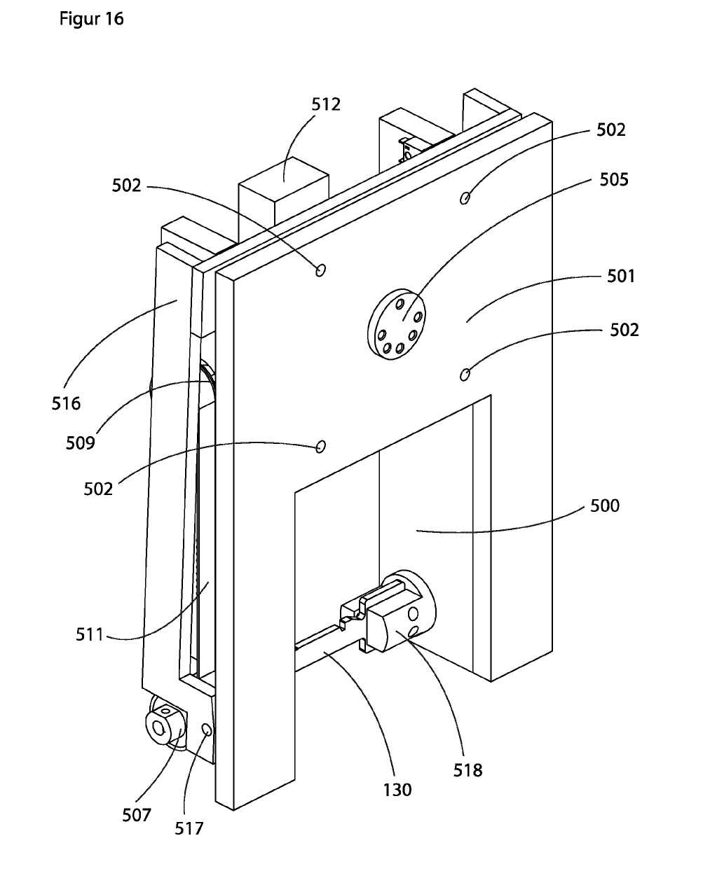

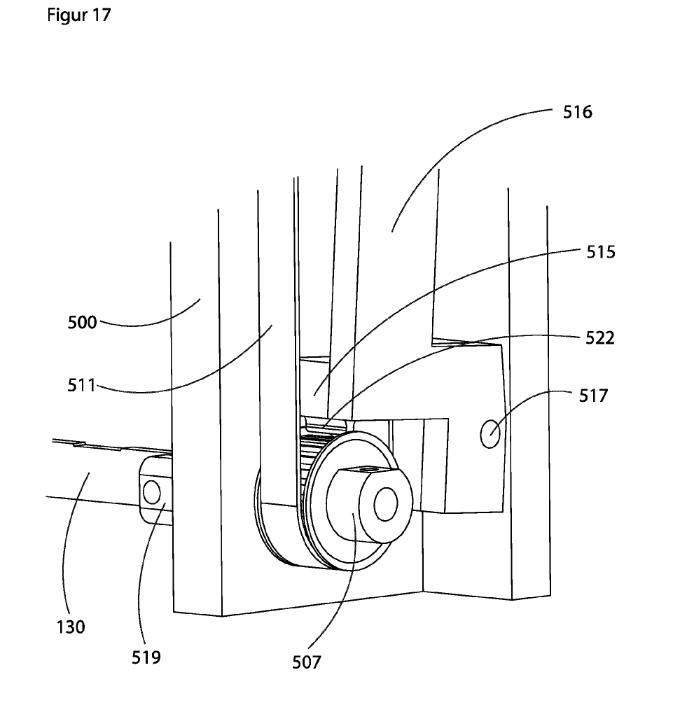

FIGS. 15, 16, 17 show an exemplary configuration of a semi-finished product module 500 for use in the processing base 301 of the manufacturing device 300 according to the invention. Here, the FIG. 15 shows the semi-finished product module 500 obliquely from the front, the FIG. 17 shows an enlarged section of it, and the FIG. 16 shows the semi-finished product module 500 obliquely from the rear. Four fixing holes 502 and a socket 505 are attached in the mounting plate 501. The rotary motor 504, the brake motor 505 and sensors are connected by the connection cable 503 to the electrical contacts of the socket 505. The head end of the semi-finished product 130 is aligned with its fitting 133 on the alignment pins 520 and thus fixed in the correct position in the clamping jaws 518 by means of a locking screw. The tip end of the semi-finished product 130 is aligned with its fitting 134 on the alignment pin 521 and thus firmly clamped in the clamping jaws 519 by means of a locking screw. One the one side, the toothed belt disc 508 is connected to the axis of the rotary motor, on the other side the toothed belt disc 509.

The rotary motor 504 is connected in a form-locking manner to the rotatably mounted clamping jaws 518 by the toothed belt disc 508, the toothed belt 510 and the toothed belt disc 506. Similarly, the rotary motor 504 is connected in a synchronized manner to the rotatably mounted clamping jaws 519 by the toothed belt disc 509, the toothed belt 511 and the toothed belt disc 507. The brake spindle 513 of the brake motor 512 is connected to the pivotably supported brake rocker 516 on the rotary axes 517. The brake blocks 514, 515 are attached to each brake gear 522 on the brake rocker 516.

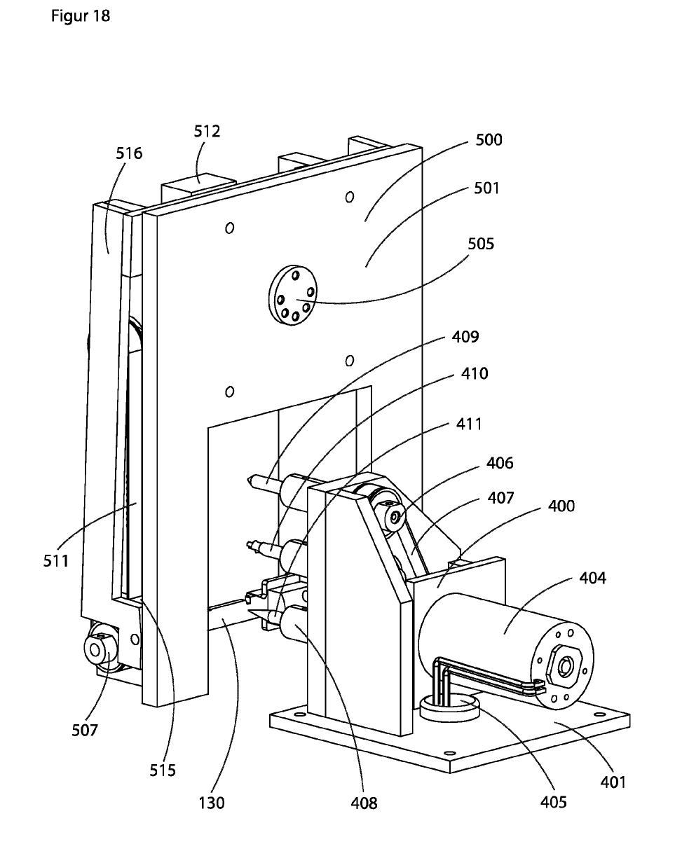

FIG. 18 shows an embodiment of a semi-finished product module 500 during processing of the semi-finished product 130 by means of an end milling cutter module 400. The mounting plate 401, the socket 405, three milling spindles 408, the end milling cutters 409, 410, 411, toothed belt wheels 406, toothed belt 407 and the motor 404 can be seen from the end milling cutter module 400. The mounting plate 501, the socket 505, the toothed belt 511, the toothed belt sprocket 507, the brake motor 512, the brake rocker 516 and the brake block 515 are visible from the semi-finished product module 500.

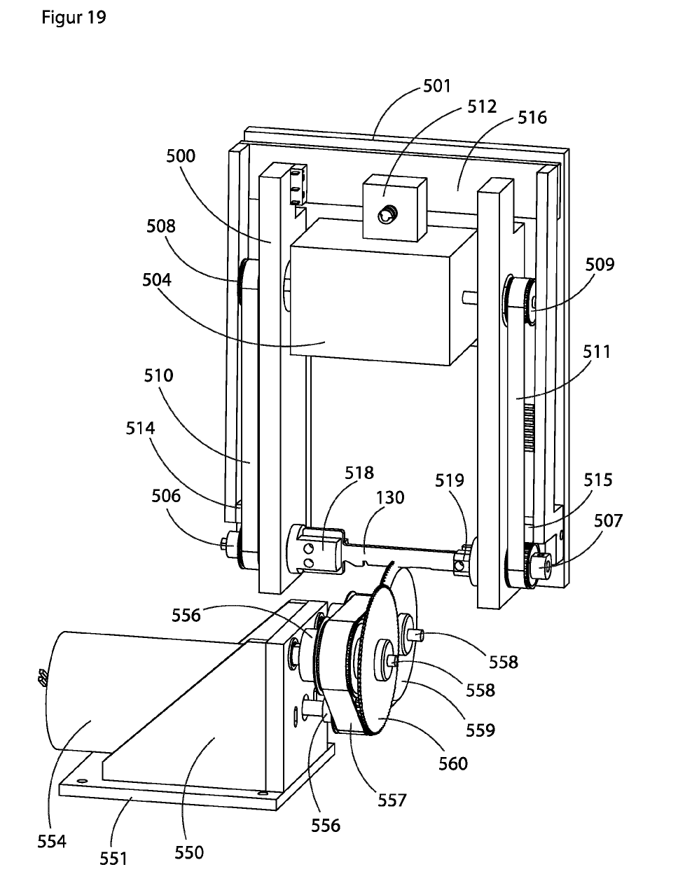

FIG. 19 shows an embodiment of a semi-finished product module 500 during processing of the semi-finished product 130 by means of a side milling cutter module 550. Mounting plate 551, milling spindles 558, toothed belt wheels 556, motor 554, toothed belt 557, side milling cutters 559, 560 are seen from the side milling cutter module 550. Mounting plate 501, clamping jaws 518, 519, rotary motor 504, toothed belt wheels 508, 509, 506, 507, toothed belt 510, 511, brake motor 512, brake rocker 516, brake blocks 514, 515 are shown from the semi-finished product 500.

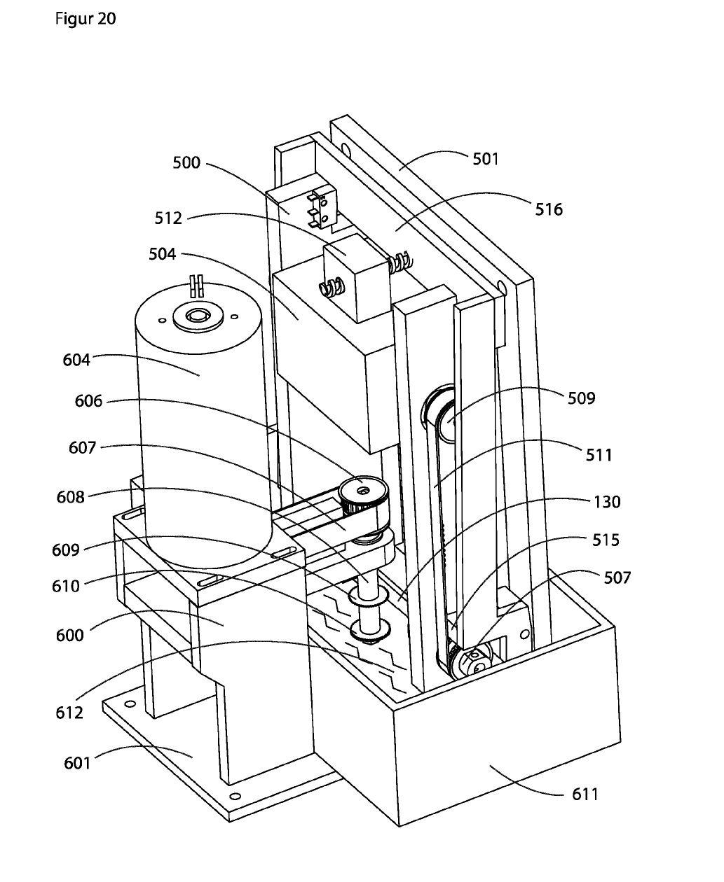

FIG. 20 shows an embodiment of a semi-finished product module 500 during processing of the semi-finished product 130 by means of a profile milling cutter module 600. Mounting plate 601, motor 604, toothed belt 607, toothed belt wheels 606, milling spindle 608, mini side milling cutters 609, 610 are visible from the profile milling cutter module 600. Mounting plate 501, rotary motor 504, toothed belt wheels 509, 507, toothed belt 511, brake motor 512, brake rocker 516, brake block 515 are visible from the semi-finished product module 500.

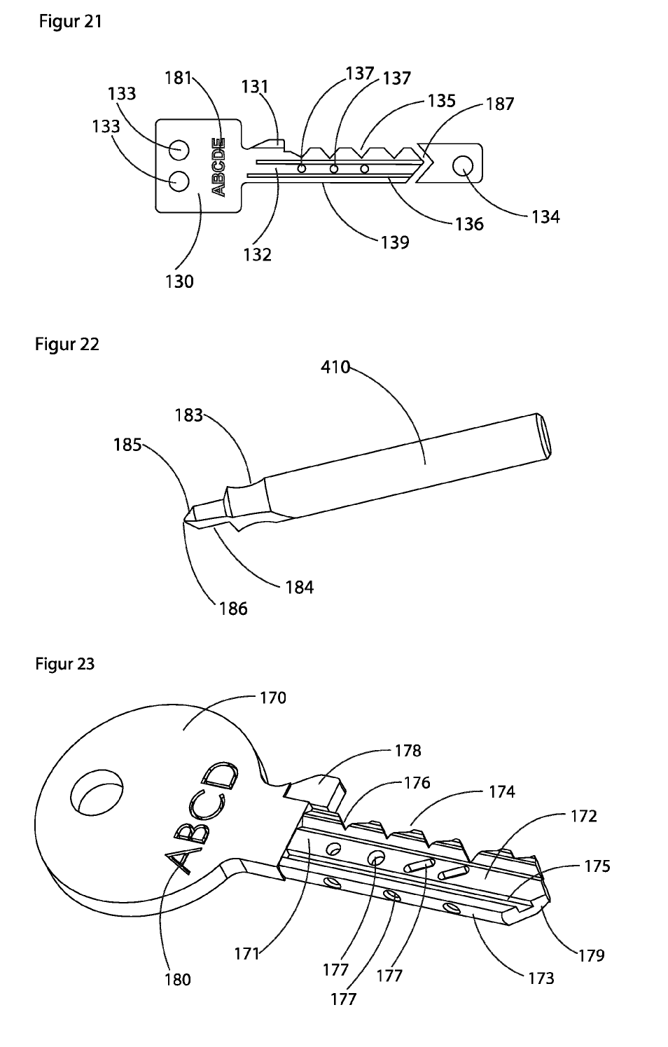

FIG. 21 shows a key manufactured from a semi-finished product 130 by means of the automated method according to the invention and a manufacturing device according to the invention. Here, the profile 136, the teeth 135, the notches 137 were milled into the semi-finished product, the stop 131 adapted, the back 139 rounded, and the inscription 181 engraved. Finally, the semi-finished product has been provided with the tip 187. The semi-finished product 130 here was fixed in the semi-finished module 500 by means of the fittings 133 and 134.

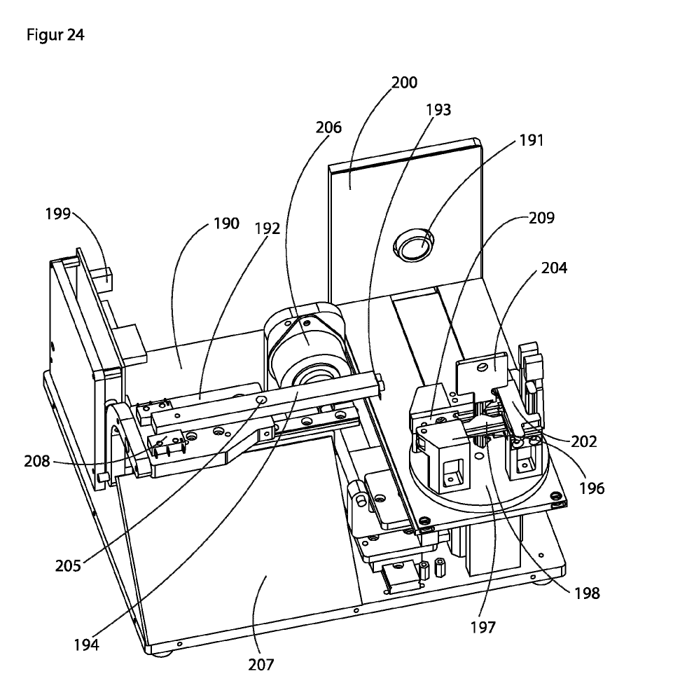

FIG. 22 shows a combination miller cutter 410 for use in an end milling cutter module 400 of the processing base 301. Through the use of combination miller cutters 410 of different design, milling modules can be saved on the processing base 301, since several locking characteristics can be milled with the same milling cutter. For example, 5 different work steps can be performed with the combination miller 410: The back of the semi-finished product can be rounded with the back milling area 183, notches can be milled in the semi-finished product with the notch milling area 185, the inscription can be engraved in the semi-finished product with the engraving area 186, and the contour of the semi-finished product shaft can be adjusted with the contour milling area 184, and the tip is milled.

FIG. 23 shows, only to better understand the technical terms, an embodiment of a conventional key 170. To manufacture an exact fitting duplicate of a key 170, the following characteristics of the original must match the duplicate: The length, width and thickness of the blade 171, the profile 175 on the broad sides 172, the round shape of the back 173, the teeth 176 on the breast 174 and possibly on the back 173, the notches 177 in the broad sides 172, back 173 and possibly breast 174, the width and height of the stop 178 and the configuration of the tip 179. For safe assignment, the engraving 180 in the head should also be identical.

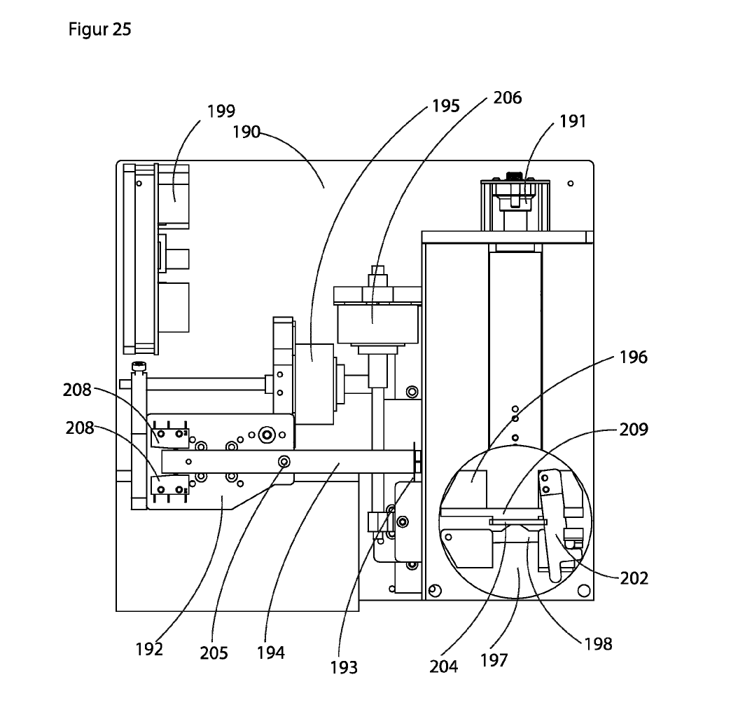

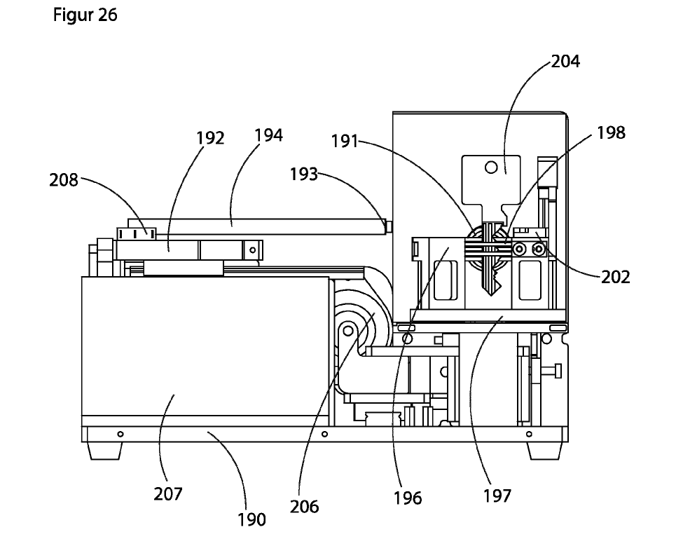

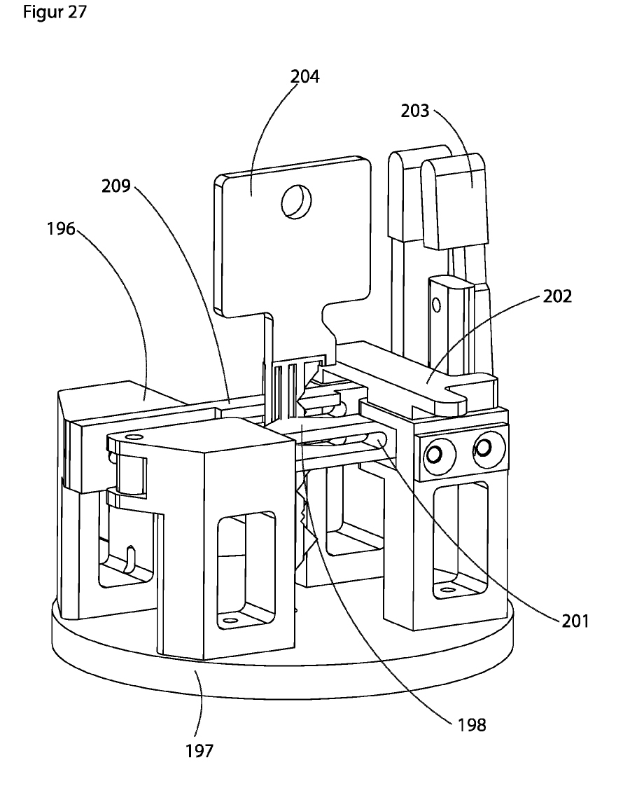

The FIGS. 24, 25, 26 show an inventive recording device 190. The computing unit 199 serves to control the electronic components and for calculating the data. The key 204 can be fixed in the key holder. The depth stop 202 serves to align the key 204 to the correct height. The spring-loaded clamping jaws 198 press the key 204 against the fixed jaws 209 and thus fix it. The key holder can be rotated about its own axis by means of the turntable 197. The camera 191 is used for the illumination of the key in which the key can be moved by means of the linear axis 206. By means of the illumination sheet 200, the keys can be illuminated for photocopying by means of the lighting film 200. The scanning unit 192 consists of a scanning bar 194 which is pivotally supported by means of the swivel joint 205. The scanning plate 193 is firmly connected to the scanning bar 194. The switch 208 switches as soon as the scanning plate 193 encounters the key during the scanning of the key profiles and thereby pivots the scanning bar 194 around the pivot joint 205. The linear axis 195 moves the scanning unit 192 to the left and right. Information on the operation of the recording device of the computing unit 199 can be displayed on the display 207.

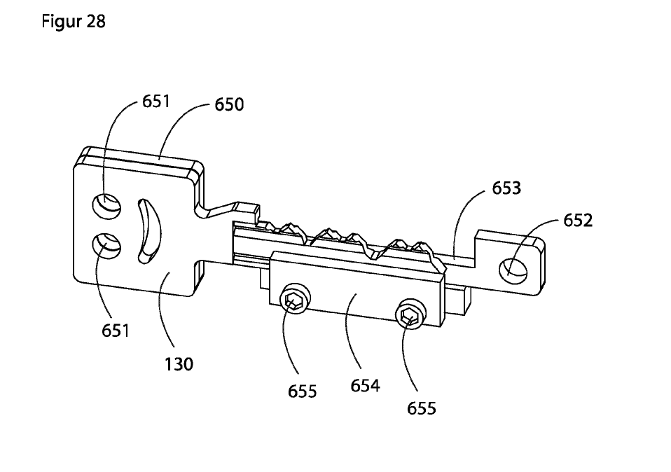

FIG. 27 shows a key holder 196 of the inventive recording device. The key 204 is fixed between the fixed jaws 209 and the clamping jaws 198. The clamping lever 203 is used to open the clamping jaws 198. The key 204 is always pressed downward so far until its stop rests on the depth stop 202. The key holder 196 is rotated by means of the turntable 197. The clamping jaws 198 have an outbreak 201 so that as little of the areas of the key as possible are covered by the clamping jaws 198 while the key is photocopied. The fixed jaws 209 also have two of these outbreaks.

FIG. 28 shows a clamping adapter 650 for the clamping of semi-finished products 130 whose tip has already been cut off, in a semi-finished product module. For this, the semi-finished product 130 is fixed in the clamping adapter 650 by means of the clamping element 654 and the clamping screws 655. The clamping adapter 650 is now aligned to the correct position together with the semi-finished product 130 to the socket 651 on the alignment pins 520, and to the fitting 652 on the alignment pin 521 of the semi-finished module 500 and fixed by means of clamping screws of the clamping jaws 518, 519. The semi-finished product 130 now lies free in the area of free section 653 of the clamping adapter 650 and can now, for example, be reworked on the teeth in the manufacturing 300 device.

The operation of the present invention is as follows:

In order to generate a data record of the surface contour of a key 204, the key 204 is clamped into the key holder 196. For this, the spring-loaded jaws 198 are loosened by means of the clamping lever 203, and the key 204 is inserted. After releasing the clamping lever 203, the spring-loaded jaws 198 hold the key 204 fixed in its position.

The key 204 is then pressed down until the key stop rests on the depth stop 202. This ensures that the blade and the profile of the key 204 a tightly defined dimension above the key holder 196 lies free. Now, the measurement process is started by means of pressing a button on the display 207, where the computing unit 199 controls all the electronic components of the recording device 190. The scanning unit 192 now moves via the linear axis 195 to the right until the scanning plate 193 fixed on the scanning bar 194 is on the left beginning of the key blade. Now, if the key 204 fixed in the key holder 196 is driven in the direction of the scanning plate 193 by means of the linear axis 206, one of the switches 208 switches the scanning bars supported around the pivot joint 205 as soon as the scanning plate 193 encounters the profile of the key blade.

The configuration of the key profile can be calculated at this point, based on the positions of the linear axes 195, 206. Now if the profile of the key 204 is scanned stepwise in this manner, the surface contour of the overall profile of the key 204 can be recorded. Now the surface of the key 204 is recorded several times by means of the camera 191. Here, the key 204 is further rotated around a fixed defined value by means of the turntable. The computing unit 199 now calculates a data record from profiles recorded by means of the scanning unit 192 and the image of the key 204 recorded by the camera 191, which reflects the entire surface contour of the key.

This data record can now be stored in electronic form, or be used to manufacture a duplicate key. If the computing unit finds a matching, commercially available key blank with the corresponding profile, the identification of this blank is displayed on the display 207. In this case, a special manufacture of the key profile is avoided.

The errors 5, 6, 7 in the data record 20 caused by the recording are now corrected by means of the data optimization 55 of the present invention, and so an error-free electronic data record 40 of the surface contour is generated, that corresponds to the key 204, 10.

To manufacture a key based on an electronic data record 40, a semi-finished product 130 is correspondingly processed by means of the manufacturing device 300. All modules required for manufacturing 400, 450, 500, 550, 600 are designed so that they can be installed quickly and easily to any module slots 315, 316, 317, 318, 319, 320 of the processing base 301, and if necessary, can be removed again. Also, the control module 350 can be exchanged for another control module by simply loosening the connection cable 354. This modular design makes it possible to mill every possible key, simply by installing the required modules in the processing base 301 according to the locking characteristics of the key to be milled. The manufacturing device 300 is thus perfectly equipped for the future, since correspondingly necessary manufacturing modules can be developed with the arrival of new locking characteristics, and these can then be incorporated easily into the processing base 301.

Three linear movable axes 303, 304, 305 are connected to the table 302 of the processing base 301 of the manufacturing device 300. By rotating the motor 306, the X axis 303 can be linearly driven to the left or right by means of the belt drive 309 and the spindle drive 312. The motor 307, belt drive 310, the spindle drive 313 move the Y axis 304 linearly forward or backward. The motor 308, belt drive 311, spindle drive 314 move the Z axis 305 up or down. Through these 3 linear axes 303, 304, 305, the module slot 320 can be driven to any point of the processing base 301. A plurality of module slots 315, 316, 317, 318, 319 with their plug contacts 321 and 4 respective locking pins 322 are found on the table 302. The module slot 320 is fastened to its plug contacts 321 and four locking pins 322 on the Z axis. Any of the modules end milling cutter module 400, control module 450, side milling cutter module 550, profile milling cutter module 600 can be installed on the module slots 315, 316, 317, 318, 319. Preferably, a semi-finished product module 500 is installed on the module slot 320. For this purpose, the modules 400, 450, 500, 550, 600 are inserted on the alignment pins 322 of the module slots 315, 316, 317, 318, 318, 319, 320, by means of the locating holes 402, 452, 502, 552, 602 of their mounting plates 401, 451, 501, 551, 601, whereby the modules 400, 450, 500, 550, 600 are locked into place in the correct position, or fixed by means of screw connections. The contacts of the sockets 405, 455, 505, 555, 605 thereby engage the corresponding module slots 315, 316, 317, 318, 319, 320 in the corresponding electrical plug contacts 321. The sockets 405, 455, 505, 555, 605 are connected to the motors 404, 554, 604, 504, 512, sensors 454 and other electronic components of the respective modules 400, 450, 500, 550, 600 by means of cables 403. The control module is thus electrically connected to each module arranged on the processing base by the cable 354 in order to send or receive control commands to these modules 400, 450, 500, 550, 600. Each of the modules 400, 450, 500, 550, 600 has an electronic identifier which is transmitted automatically when plugging in a module slot on the control module 350. Thus, the computing unit receives information about where to find which module and what particular setup values the corresponding modules require. The computing unit is capable of reading the bar codes 412, 413, 414, 561, 562 of the milling cutters 409, 410, 411, 559, 560 via the camera 323 and thus recognize where each router is clamped. In addition, the milling process can be filmed by the camera 323 to analyze errors in the manufacturing device be means of remote diagnostics.

The end milling cutter module 400 has a motor 404 which drives the three milling spindles 408 by means of the toothed belt wheels 406 and the toothed belt 407. The end milling cutters 409, 410, 411, equipped with different cutting geometry, are used in these milling spindles 408. A variety of different millings can thus be attached to this end milling cutter module 400 in this semi-finished product 130. The end milling cutter 409 can mill cavities 137 in different sizes, the end milling cutter 410 is suitable for milling the back 139, the stopper 131, the top 187, the identifier can be engraved with the end milling cutter 411. The most distinctive key can be manufactured by the variety of different milling cutters 409, 410, 411, without requiring a replacement of the milling cutter. The end milling cutters 409, 410, 411 are equipped with appropriate bar codes 412, 413, 414. Thus, the computing unit 351 can detect the orientation and position of all milling cutters 409, 410, 411, 559, 560, 609, 610 via the camera 323.

The side milling cutter module 550 drives the two milling spindles 558 by means of toothed belt wheels 556, the toothed belt 557 and the motor 554. The side milling cutter 559 clamped in the milling spindle 558 can mill teeth 135 tapered downward into the semi-finished product 130. The side milling cutter 560 is suitable for the milling of straight cuts.

The profile milling cutter module 600 is equipped with the motor 604 in order to drive the milling spindle 608 by means of the toothed belt wheels 606 and the toothed belt 607. Two different mini disc milling cutters 609, 610 are clamped in the milling spindle 608. Any profile 136 can be milled into the semi-finished product with these two mini disc milling cutters 609, 610. At this point, the mini disc milling cutters 609, 610 and semi-finished product 130 are immersed in the coolant 612 of the coolant tank 611 in order to lubricate and cool the milling cutters 609, 610 and the semi-finished product 130.

The control module 450 has a control bar 456 which is rotatably mounted on the rotation axis 458. The control needle 457 is firmly connected to the control bar 456. Now, if the semi-finished product 130 moves toward the control needle 457, the control bar 456 pivots toward the sensor 454 as soon as the semi-finished product 130 contacts the control needle 457. The signal from the sensor 454 is detected by the computing unit 351. If the semi-finished product 130 is scanned in this way before and after a milling operation, the depth of the milling can be monitored and in addition, the location of a newly clamped milling cutter be detected. The manufacturing device 300 can thus even be calibrated in this way.

The semi-finished product module 500 is used for holding and guiding a semi-finished product 130 during processing on the processing base 301. The semi-finished product 130 is aligned to the alignment pins 520 of the clamping jaws 518 by means of its fittings 133, and fixed by means of a screw. In addition, the semi-finished product 130 is aligned to the alignment pin 521 of the clamping jaws 519 by means of its fittings 134, and fixed with a screw. Both clamping jaws 518, 519 are rotatably mounted in the semi-finished product module 500 and connected to the toothed belt wheels 506, 507. The two toothed belt wheels 508, 509 sit on the continuous axis of the rotating motor 504, which are connected to the two toothed belts 510, 511 with the toothed belt wheels 506, 507. The semi-finished product 103 can be rotated around its longitudinal axis by the rotation of the rotary motor 504. The brake motor 512 can be swing the rotatably mounted brake rocker 516 around the rotary axes 517 by means of the brake spindle 513. The brake blocks 514, 515 fastened to the brake blocker 516 thus move up and down. Now, if the brake blocker 516 pivots backwards, the brake blocks 514, 515 rise, and the semi-finished product 130 can be rotated by the rotary motor 504. If the brake blocker 516 swings forward, the brake blocks 514, 515 sink. At this point, the brake gears 522 of brake blocks 514, 515 engage the corresponding teeth of the toothed belt wheels 506, 507 and thus lock the semi-finished product 130 around its longitudinal axis of rotation. The toothed belt wheels 506,507 preferably have 24 teeth, so that the semi-finished product 130 can rotate and lock about its longitudinal axis in 15-degree increments. The semi-finished product 130 can thus be processed by means of the milling modules 400, 550, 600 while being rotated about the longitudinal axis, or while it is locked in one of the 15-degree positions. The semi-finished product module 500 can be made watertight by means of two enclosures around the components of the belt drives 508, 510, 506 and 509, 511, 507 in order to prevent the entry of cooling liquid 612.

The computing unit 351 of the control module 350 calculates the required manufacturing steps for the manufacture of a key based on data record present in the computing unit 351 of the control module 350 and outputs this information to the final stage 352 of the control of the motors of the processing base. The cable 354 connects the control module to the machining base 301 and is connected to the motors 306, 307, 308 of the linear axes and their sensors. In addition, all plug contacts 321 of the module slots 315, 316, 317, 318, 319, 320 are connected to the cable 354. All motors and sensors of the modules 550, 600, 450, 400, 500 inserted on the module slots are connected to the cable 354 and thus with the control module 350 via their sockets 405, 455, 505, 555, 605. The entire manufacturing device 300 is supplied with current by means of the batteries 353 and is thus also suitable for mobile use.

Now if a key is manufactured on the basis of a manufacturing data record 40 present in the computing unit 351, the computing unit checks whether all modules 550, 600, 450, 400, 500 necessary for the manufacture of this key and the necessary cutters are installed on the processing base 301. If not, the user is prompted on the screen 355 of the control module 350 to install the appropriate modules/milling cutters on the manufacturing base 301. In this case, the control module 350 monitors the automatic calibration of the modules and the milling cutters. Now, a semi-finished product 130 is clamped into the semi-finished product module 500 and the processing starts on the control module. Due to the variety of modules and milling cutters, it is possible to have the once clamped semi-finished product 130 clamped during the complete production process, without needing to shift or readjust the semi-finished product 130. The complete manufacture of the key runs fully automatically. The semi-finished product 130 is rotated into the correct position by the rotary motor 504 and fixed into its position by the brake motor 512.

The semi-finished product 130 is now positioned by moving the linear axes 303, 304, 305 via the coolant tank 611 of the profile milling cutter module 600 and immersed in the coolant 612. The motor 604 is started around the milling spindle 608 and the mini disc milling cutters 609, 610 should be shifted in rotation. By moving the linear axes 303, 304, 305, the required profile 136 can now be milled into the semi-finished product 130. The second side of the profile 136 can then either be milled on the opposite side of the mini disc milling cutters 609, 610 or the semi-finished product 130 is rotated 180 degrees in the semi-finished product module 500.

Now the semi-finished product 130 is driven near the disc milling module 550 by means of the linear axes 303, 304, 305 in order to be processed there by the side milling cutters 559, 560. Again, in a simple way, the semi-finished product 130 can be rotated by the rotary motor 504 around teeth 135 or to mill straight cuts in both sides of the semi-finished product 130.

Now the semi-finished product 130 is positioned in the vicinity of the end milling cutter module 400 in order to be processed there in the corresponding way by the end milling cutters 409, 410, 411. By turning the semi-finished product 130 by means of the rotary motor 504, drill notches 137 can be milled into the semi-finished product 130 with the end milling cutter 409 at any point. The end milling cutter 411 can be used by its combined structure in order to manufacture the back 139, the stop 131, the tip 187 of the semi-finished product/key 130. The end milling cutter 411 can engrave an identification in the head of the semi-finished product 130.

If additional milling cutters are required for the manufacture of the key, an additional milling module 400, 550 can be installed on the free module slot 319 before starting the manufacturing.

The manufacture is now complete and the fully processed semi-finished product 130 now matches the data record of a key present in the control module 350. Throughout the manufacture, the semi-finished product 130 can remain in its clamping, which otherwise prevents common shift tolerances.

The milling result can be checked at any time in the semi-finished product 130 by the control module 450. Before the milling, the semi-finished product 130 is therefore driven to the corresponding location against the control needle 457 until the sensor 454 is triggered by the deflection of the control bar 456. After milling, this is repeated and thus through a comparison of the deflection position, the milling result is monitored by a target/actual comparison.

The following procedure describes the automatic setup of a module example based on the end milling cutter module 400 on the module slot 318 of the table 302. The mounting plate 401 of the module 400 is plugged into the module slot 318 so that the four fixing holes 402 snap into the four locking pins 322. In this way, the end milling cutter module 400 is connected fixedly to the table of the processing base 301 by means of an optional screw connection. At the same time, the contacts of the socket 405 create electrical contact with the plug contacts 321. The end milling cutter module 400 sends its identification and its individual setup data via this electronic connection, which is stored in a memory chip on the computing unit 351 of the control module 350. The control module 350 now has the user, on its screen 355, clamp a semi-finished product 130 into the semi-finished product module 500. The processing base 301 automatically drives the semi-finished product 130 to the control module 450 in order to scan the surface of the semi-finished module 130. The values are buffered into the computing unit 351. Now the camera 323 fastened to the Z axis 305 moves over the end milling cutter module 400 and reads in the bar code 412, 413, 414 of the end milling cutters 409, 410, 411 and thereby detects the model of this end milling cutter. Now each particular area of the semi-finished product 130 is milled with the end milling cutters 409, 410, 411. The locations thus milled are automatically measured again in the control module 450. These values are compared with the values previously stored so as to calculate the clamping position and the geometry of the end milling cutters 409, 410, 411 in the respective milling spindles 408 and to save it into the computing unit 351. The end milling cutter module 400 is now automatically, fully calibrated and can be used.

1. A method for manufacturing a key (50), comprising the following steps:
(a) obtaining a data record (40) of a key bye recording (2, 3, 4) a surface of the key (10, 204) with subsequent data optimization (55), or through the acquisition of data from a data collection (46) to obtain a semi-finished product (130);
(b) clamping the semi-finished product (130) into a semi-finished product module (500);
(c) machining the semi-finished product (130) by a manufacturing device (300) such that at least two different locking characteristics (131, 132, 135, 136, 137, 139, 187, 181) are formed in the semi-finished product (130) in order to manufacture the key (50).

2. A method according to claim 1, wherein the recording of the surface of the key (10, 204) is performed by means of one of (a) laser line triangulation (2), (b) mechanical sensor elements (3), (c) a camera (4) and (d) a combination of (a), (b) and (c).

3. A method according to claim 2, wherein the surface of the key (10, 204) is recorded mechanically and optically in order to combine the data from these two methods by a computing unit (199) to create a data record (20).

4. A method according to claim 2, wherein the profile of the key (10, 204) is recorded by tactile scanning by means of a scanning plate (193), and the surface of the key (10, 204) is recorded by means of a camera (191).

5. A method according to claim 2, wherein the key (10, 204) is rotated axially during the optical detection.

6. A method according to claim 1, wherein during the data optimization (55), errors and/or deviations of the data record (20) are corrected and/or missing data is padded into the data record (20).

7. A method according to claim 6, wherein the data of the data optimization (55) originates from a database (1), and/or from the recorded data record (20).

8. A method according to claim 6, wherein the data optimization (55) is effected manually and/or by means of software in a computer, which drives the computer-controlled manufacturing processes (9) in the machine.

9. A method according to claim 6, wherein the error (6) of the profile (22) of the recorded data record (20) are optimized by means of error-free profile sections (26) of the recorded data record (20), by means of profile sections (33, 36) and/or by means of profile sections (37, 38) of the database (1).

10. A method according to claim 6, wherein the error (7) of the tumblers (24) of the recorded data record (20) are corrected by means of error-free tumblers (24) of the recorded data record (20), by means of further tumblers (34) and/or by means of a tumbler pattern (39) of the database (1).

11. A method according to claim 6, wherein faulty tumblers (29) of the recorded data record (20) are corrected by means of error-free tumblers (25) and/or missing depths of the tumblers (25) are supplemented by means of depth references (51).

12. A method according to claim 6, wherein the data records are sorted hierarchically in the database (1).

13. A method according to claim 6, wherein the data optimization (55) for the generation of the data record (40) factoring in corresponding manufacturing tolerances.

14. A method according to claim 6, wherein the data optimization (55) for the generation of the data record (40) factoring in corresponding tolerances of the key series or makes.

15. A method according to claim 1, wherein the data are used to determine a corresponding key blank.

16. A method according to claim 1, wherein the fixation of the semi-finished product (130) takes place on the head (133) and/or the tip (134) in the semi-finished product module (500), whereby the semi-finished product (130) is freely accessible for the manufacturing device (300) during the formation of the lock characteristics.

17. A method according to claim 1, wherein the formation of the lock characteristics (131, 132, 135, 136, 137, 139, 187, 181) is performed in the semi-finished product (130) by means of milling and/or drilling.

18. A method according to claim 17, wherein the semi-finished product (130) be is movable linearly and/or rotationally in different directions.

19. A method according to claim 18, wherein the semi-finished product (130) can be rotated in the semi-finished product module (500).

20. A method according to claim 19, wherein the different lock characteristics are formed by means of milling modules (400, 550, 600) installed on a processing base (301), wherein the milling modules (400, 550, 600) can be rotated, tilted and/or moved on the processing base (301).

21. A method according to claim 17, wherein the axes (303, 304, 305) and the modules (400, 450, 500, 550, 600) are controlled by a computing unit (351) and a final stage (352) of the control module (350), according to the data of a key in the computing unit (351).

22. A method according to claim 21, wherein the modules (350, 400, 450, 500, 550, 600) on the module slots (315, 316, 317, 318, 319, 320) of the manufacturing device (300) can be installed or uninstalled at will.

23. A method according to claim 22, wherein the stop (131), notches (137), the back (139), the tip (187) can be introduced at any point of the semi-finished product (130) by shank cutter (409, 410, 411) of the end milling cutter module (400).

24. A method according to claim 23, wherein variously shaped teeth (135) are introduced into the semi-finished product (130) by the side milling cutter (559, 560) of the side milling cutter module (550).

25. A method according to claim 24, wherein a profile (136) is introduced on any sides of the semi-finished product (130) by the mini side milling cutter (609, 610) of the profile milling cutter module (600).

26. A method according to claim 25, wherein the processing of the semi-finished product (130) automatically runs by means of the modules (400, 450, 500, 550, 600), and the semi-finished product (130) remains clamped during the entire processing in the semi-finished product module (500).

27. A method according to claim 26, wherein the semi-finished product module (130) is cooled and lubricated during processing by means of a coolant (612).

28. A method according to claim 27, wherein the modules (350, 400, 450, 500, 550, 600) in the manufacturing device (300) are automatically aligned and calibrated, and are managed through the control module (350) according to the key to be milled.

29. A method according to claim 28, wherein the manufacturing device (300) is monitored by means of the camera (323) and the camera (323) reads in the bar codes (412, 413, 414, 561, 562) for recognition and calibration of the milling cutter (409, 410, 411, 559, 560).

30. A method according to claim 29, wherein the position and the milling of the semi-finished product (130) can be determined by the control module (450).

31. A method according to claim 30, wherein the semi-finished product (130) is clamped and fixed in the semi-finished product module (500) in order to be able to rotate its longitudinal direction, and the rotation of the semi-finished product (130) is locked in several positions.

32. A method according to claim 31, wherein the manufacturing device (300) is modularly constructed, and the user is prompted by the control module (350) before the processing of the semi-finished product (130), according to required modules (350, 400, 450, 500, 550, 600) or milling cutter (409, 410, 411, 559, 560, 609, 610) to be installed.

33. A method according to claim 2, wherein the recorded data of the key (10, 204) are stored in an electronic data record by the computing unit (199).

34. A method according to claim 2, wherein the identification of a matching semi-finished product or key blank for the key (10, 204) is determined.

35. A device for recording the surface of a key (10, 204) comprising a scanning unit (192), a key holder (196), a computing unit (199), and a camera (191).

36. A device according to claim 35, wherein the key holder (196) comprises a turntable (197), a clamping jaw (198), a depth stop (202), a clamping lever (203), and fixed jaws (209), wherein the clamping jaws (198) and the fixed jaws (209) have at least one or more nicks.

37. A device according to claim 35, wherein the scanning unit (192) has a scanning bar (194), a scanning plate (193), a rotary joint (205) and a switch (208).

38. A device for manufacturing a key from a semi-finished product (130) comprising a control module (350), a processing base (301), a semi-finished product module (500), and a profile milling cutter module (600).

39. A device according to claim 38, further including an end milling cutter module (400), a control module (450), and a side milling cutter module (550).

40. A device according to claim 38, further including a control module (350) comprising a computing unit (351), a final stage (352), a screen (355) an energy delivery unit (353), a connecting cable (354), a transport box, and a network connection.

41. A device according to claim 40, wherein the processing base (301) comprises a plurality of movement axes (303, 304, 305), a plurality of module slots (315, 316, 317, 318, 319, 320), and a camera (323).

42. A device according to claim 41, wherein the movement axes (303, 304, 305) are respectively driven by a motor (306, 307, 308), a belt drive (309, 310, 311), a spindle drive (312, 313, 314).

43. A device according to claim 41, wherein the module slots (315, 316, 317, 318, 319, 320) each contain plug contacts (321), and locking pins (322).

44. A device according to claim 38, including a semi-finished product module (500) comprising a mounting plate (501) with fixing bores (502), connection cable (503), socket (505), toothed belt wheels (506, 507, 508, 509) toothed belt (510, 511), motors (512, 504), brake spindle (513), brake blocks (514, 515) with brake gear (522), brake rocker (516), rotary axes (517) clamping jaws (518, 519) with alignment pins (520, 521), and a clamping adapter (650).

45. A device according to claim 44, wherein the clamping adapter (650) contains fittings (651, 652), a free punch (653), and a clamping element (654) with clamping screws (655).

46. A device according to claim 45, wherein the end milling cutter module (400) comprises a mounting plate (401) with fixing bores (402), connection cable (403), motor (404), socket (405), toothed belt wheels (406), toothed belt (407), milling spindles (408), and end milling cutters (409, 410, 411), equipped with bar code (412, 413, 414).

47. A device according to claim 46, wherein the end milling cutter (410) comprises a back milling area (183), a contour milling area (184), a notch milling area (185) and an engraving area (186).

48. A device according to claim 47, wherein the control module (450) comprises a mounting plate (451) with fixing bores (452), connection cable (453), sensors (454), a plug socket (455), a control bar (456) with control needles (457) and the rotational axis (458).

49. A device according to claim 48, wherein the side milling cutter module (550) comprises a mounting plate (551) with fixing bores (552), connection cable (553), a motor (554), a socket (555), toothed belt wheels (556), toothed belt (557), milling spindles (558), and side milling cutters (559, 560) with bar code (561, 562).

50. A device according to claim 49, wherein the profile milling cutter module (600) comprises a mounting plate (601) with fixing bores (602), connection cable (603), a motor (604), a socket (605), toothed belt wheels (606), toothed belt (607), a milling spindle (608), mini disc milling cutters (609, 610), and a coolant container (611) with coolant (612).

51. (canceled)
